(19) United States
(12) Patent Application Publication
(10) Pub. No.: US 2012/0307523 A1
(43) Pub. Date: Dec. 6, 2012

(54) LIGHT SOURCE DEVICE AND DISPLAY DEVICE

(75) Inventor: Tomoaki Oya, Osaka-shi (JP)

(73) Assignee: SHARP KABUSHIKI KAISHA, Osaka-shi, Osaka (JP)

(21) Appl. No.: 13/579,358

(22) PCT Filed: Dec. 6, 2010
(86) PCT No.: PCT/JP2010/071800

§ 371 Date: Aug. 16, 2012

(30) Foreign Application Priority Data
Feb. 25, 2010 (JP) 2010-040107

(51) Int. Cl. F21V 8/00

(52) U.S. Cl. 362/612; 362/613

(57) ABSTRACT

Provided is a light source device capable of minimizing or preventing a decrease in amount of light emitted from portions in the vicinity of a locking member of a light guide plate, and capable of making intensity distribution in a plane of light emitted from the light guide plate uniform. The light source device includes a light guide plate 13 (13a, 13b) including a locking member 131a, 131b for disposition and fixing that is disposed on a peripheral portion of the light guide plate or disposed in a vicinity of the peripheral portion, and
a light source (15a) capable of projecting light onto the peripheral portion, wherein the light that is projected from the light source onto portions of the light guiding plate, the portions being in the vicinity of the locking member, is higher in intensity than the light projected onto the other portions of the light guiding plate.

### TECHNICAL FIELD

The present invention relates to a light source device and a display device, and more specifically relates to a side light source device (referred to also as a side backlight unit or an edge light backlight unit) that is used in a display device, and a display device including the side light source device.

### BACKGROUND ART

A display device including a transflective or transmissive display panel (e.g., a transflective or transmissive liquid crystal display panel) usually includes a light source device (referred to also as a backlight) disposed behind the display panel. Light emitted from the light source device is projected onto a back face of the display panel, whereby an image is displayed visible on a front face of the display panel.

A side light source device (referred to also as a side backlight unit or an edge light backlight unit) is one example of a light source device used in the display device. A conventionally-used general side light source device includes a linear light source and a light guide plate, where the linear light source is disposed closed to a lateral side of the light guide plate. The light emitted from the light source is guided to the inside of the light guide plate from an end face at the lateral side of the light guide plate, and is emitted to the outside from a front face of the light guide plate (i.e., projected onto the back face of the display panel).

A general light guide plate has a plate shape and a given thickness, and is arranged to planarly diffuse the light emitted from the liner light source (i.e., is arranged to transform the liner light source to a planar light source). The light, which is emitted from the front face of the light guide plate, needs to have uniform intensity distribution in its plane in order to prevent luminance unevenness from developing in an image displayed on the display panel of the display device. Thus, the general light guide plate includes asperities (referred to as “emboss” or “frosting”) formed or coated on its back face, which are arranged to reflect and diffuse the light.

The light guide plate needs to be disposed on or fixed to a chassis of the light source device so as not to be displaced nor fall. A mechanism or a structure used for disposing or fixing the light guide plate to the chassis needs to have a configuration such that intensity distribution in the plane of the light emitted from the front face of the light guide plate is not made nonuniform. A double-faced tape is preferably used to fix the light guide plate to the chassis; however, the light guide plate cannot be always disposed in a convincing way or fixed firmly to the chassis with the double-faced tape, so that if an impact or vibrations are given to the light source device, the light guide plate could be displaced or fall.

Configurations are disclosed in PTLs 1 and 2, which can prevent intensity distribution in the plane of the light emitted from the light source device from becoming nonuniform while allowing the light guide plate to be disposed in a convincing way or fixed firmly.

Disclosed in PTL 1 is the light source including protrusions disposed on a lateral face of the light guide plate, and notches disposed on a frame arranged to house the light guide plate. The protrusions of the light guide plate engage with the notches disposed on the frame, whereby the light guide plate is disposed in the frame. In this light source, notches, which are along a thickness direction of the light guide plate, are provided at end portions of the protrusions of the light guide plate, the end portions being on farther sides from a light source, which can prevent luminance unevenness caused by the light that reflects at the protrusions.

Disclosed in PTL 2 is the light source including a boring or a notch disposed on a peripheral portion of the light guide plate, and a protrusion or a column disposed in a case arranged to house the light guide plate. The boring or the notch of the light guide plate engage with the protrusion or the column of the case, whereby the light guide plate is disposed on or fixed to the case. The light guide plate includes diffusion transmissive members, and the area of diffusion transmissive members is set so as to constitute a larger percentage of the light guide plate in portions in the vicinity of the boring or the notch than the other portions, which can prevent intensity distribution from becoming nonuniform.

However, the configurations disclosed in PTLs 1 and 2 have problems as follows.

In the configuration disclosed in PTL 1, a positional relation between the light source and the protrusions of the light guide plate is limited, which decreases flexibility in disposition and structure of the light source. In other words, the light source needs to be disposed on a lateral side among the lateral sides of the light guide plate, the side not including the protrusions, in order to obtain the action and effect described in PTL 1. Thus, if light sources are disposed on all the lateral sides of a light guide plate, the action and effect described in PTL 1 cannot be obtained. In addition, when a light source is displaced on a lateral side of the light guide plate where a protrusion is disposed, it is necessary that the light source and the protrusion do not interfere with each other. Thus, when the light source is displaced on the lateral side of the light guide plate where the protrusion is disposed, the light source cannot be always disposed at a favorable position.

Meanwhile, in the configurations disclosed in PTL 2, the boring (and the protrusion that engages with the boring) or the notch (and the column that engages with the notch) disposed on the peripheral portion of the light guide plate interrupt the light that is guided to the light guide plate. In other words, when the light guide plate includes the notch disposed on the peripheral portion of the light guide plate, the light emitted from the light source cannot be guided to the inside of the light guide plate from the notch. In addition, when the light guide plate includes the boring disposed on the peripheral portion of the light guide plate, the light guided from the outside of the boring (from a portion of the peripheral portion that is closest to the boring) is interrupted by the boring, and cannot travel more inside of the boring (cannot travel beyond the boring). As a result, the amount of the light that is guided to a portion of the light guide plate in the vicinity of the notch or the boring is smaller than the amount of the light that is guided to the other portions of the light guide plate, so that the intensity of the light that is emitted to the front from the portion in the vicinity of the notch or the boring decreases compared with the intensity of the light that is emitted to the front from the other portions of the light guide plate. Thus, intensity distribution in the plane of the light emitted from the light source device becomes nonuniform.

### CITATION LIST

### Patent Literature

PTL 1: JP2005-302485

PTL 2: JP H06-186432

### SUMMARY OF INVENTION

### Technical Problem

An object of the present invention is to provide alight source device that is capable of making intensity distribution in a plane of emitted light uniform (or, capable of preventing non-uniformalization of the intensity distribution) while allowing a light guide plate to be disposed or fixed, and to provide a display device that is capable of preventing luminance unevenness from developing in an image screen.

### Solution to Problem

To achieve the objects and in accordance with the purpose of the present invention, a light source device of the present invention includes a light guide plate including a locking member for disposition and fixing that is disposed on a peripheral portion of the light guide plate or disposed in a vicinity of the peripheral portion, and alight source that is capable of projecting light onto the peripheral portion of the light guide plate, wherein the light that is projected from the light source onto portions of the light guiding plate, the portions being in a vicinity of the locking member, is higher in intensity than the light that is projected onto the other portions of the light guiding plate.

It is preferable that the light source includes a plurality of light emitting elements disposed along the peripheral portion of the light guide plate, and that the light emitted by the light emitting elements in the vicinity of the locking member disposed on the peripheral portion of the light guide plate is higher in intensity than the light that is emitted by the other light emitting elements.

It is preferable that the plurality of light emitting elements define LED packages, and that the number of LED chips that the light emitting elements in the vicinity of the locking member disposed on the peripheral portion of the light guide plate include is larger than the number of LED chips that the other light emitting elements include.

It is preferable that the light source includes the light emitting elements arranged to emit different kinds of light that are different in intensity, and that the light emitting elements that emit light higher in intensity are disposed to be able to project the light onto the portions in the vicinity of the locking member disposed on the peripheral portion of the light guide plate, and that the light emitting elements that emit light lower in intensity are disposed to be able to project the light onto the other portions of the light guide plate.

It is preferable that the light emitting elements define LED packages, and that the number of LED chips that the light emitting elements that emit light higher in intensity include is larger than the number of LED chips that the other light emitting elements include.

It is preferable that the light source includes the plurality of light emitting elements disposed along the peripheral portion of the light guide plate, and that the light emitting elements in the vicinity of the locking member disposed on the peripheral portion of the light guide plate are disposed at a higher density than the other light emitting elements.

It is preferable that the plurality of light emitting elements define LED packages.

It is preferable that the light source includes a substrate including the plurality of light emitting elements.

It is preferable that the locking member disposed on the peripheral portion of the light guide plate defines a notch or a through hole.

In another aspect of the present invention, a display device includes the light source device described above and a transmissive or transflective display panel, on a back face of which the light source device is disposed, wherein the light emitted by the light source of the light source device is made into planar light by the light guide plate of the light source device, and is projected onto the back face of the display panel.

### Advantageous Effects of Invention

Because the light source device of the present invention has the configuration that the light that is projected onto the portions in the vicinity of the locking member is higher in intensity than the light that is projected onto the other portions, the amount of the light that is guided to the portions in the vicinity of the locking member disposed on the peripheral portion of the light guide plate (the amount of the light that is guided to the inside of the light guide plate from the portions in the vicinity of the locking member) can be increased compared with the amount of the light that is guided to the other portions. Thus, a decrease in intensity of the light that is emitted to the front from the portions in the vicinity of the locking member can be minimized or prevented. Consequently, intensity distribution in the plane of the light emitted from a front face of the light guide plate can be made uniform (or, non-uniformalization can be minimized or prevented).

In other words, the amount of the light that is guided to the portions in the vicinity of the locking member can be made almost equal to the amount of the light that is guided to the other portions. That is, even if the light is not guided to the inside of the light guide plate via the locking member, the light that is higher than other portions is guided to the portions in the vicinity of the locking member, which can compensate for the amount of the light that should have been guided if the locking member were not provided. Thus, decrease in intensity of the light that is emitted to the front from the portions in the vicinity of the locking member can be minimized or prevented compared with the light that is guided to the front from the other portions, which can make intensity distribution in the plane of the light emitted from a front face of the light guide plate uniform (or, non-uniformalization can be minimized or prevented).

The light guide plate is disposed on and/or fixed to a chassis of the light source device because a given member or a structure engages with the locking member. Having the configuration that the light guide plate can be disposed in a convincing way or fixed firmly, the light guide plate can be firmly in a convincing way disposed on and/or fixed to the chassis compared with the configuration using the double-faced tape, which can make intensity distribution in the plane of the light emitted from the front face of the light guide plate uniform (or, non-uniformalization can be minimized or prevented) while allowing the light guide plate to be firmly in a convincing way disposed on and/or fixed to the chassis.

It is unnecessary to provide a protrusion on the peripheral portion of the light guide plate, so that the position or the structure of the light source is not limited thereby. Thus, the light source can be disposed on the entire peripheral portion of the light guide plate (can be disposed around the entire perimeter of the light guide plate). This configuration can maintain intensity distribution in the plane of the light emitted from the light guide plate uniform while facilitating adjustment of the amount of the light.

Further, it is unnecessary to provide a protrusion on the peripheral portion of the light guide plate, so that the outer shape of the light guide plate (i.e., the shape of the peripheral portion of the light guide plate) can be simplified, which can thus simplify the structure or shape of the light source disposed on the peripheral portion of the light guide plate (or, complexity can be minimized or prevented). In this configuration, it is easy to design or set a clearance between the peripheral portion of the light guide plate and the light source, which is provided as a measure against thermal expansion of the light guide plate. In addition, because the peripheral portion of the light guide plate has a simple shape (e.g., a linear shape), the clearance between the peripheral portion of the light guide plate and the light source is made uniform easily. Thus, the amount of the light that is guided to the light guide plate can be made uniform easily.

Because the display device of the present invention has the configuration that intensity distribution in the plane of the light projected onto the back face of the display panel is made uniform, development of luminance unevenness in an image displayed in the display panel can be minimized or prevented. Thus, the display device of the present invention has excellent image display quality.

### BRIEF DESCRIPTION OF DRAWINGS

FIG. 1 is an exploded perspective view showing a schematic configuration of a relevant part of a light source device of a first embodiment of the present invention.

FIGS. 2A and 2B are external perspective views showing schematic configurations of a light guide plate, where FIG. 2A shows the light guide plate including notches that define locking members, and FIG. 2B shows the light guide plate including through holes (through holes that penetrate in a back/forth direction) that define locking members.

FIG. 3 is an external perspective view showing a schematic configuration of a light source that is used in the light source device of the first embodiment of the present invention.

FIG. 4 is a cross-sectional view schematically showing a portion of an inner structure of the light source device of the first embodiment of the present invention, and showing in particular a relation between the light source and the light guide plate.

FIGS. 5A and 5B are plan views schematically showing a positional relation between the light sources and the light guide plate, where FIG. 5A shows a positional relation between the light sources and the first light guide plate, and FIG. 5B shows a positional relation between the light sources and the second light guide plate.

FIG. 6 is an external perspective view showing a schematic configuration of light sources that are used in a light source device of a second embodiment of the present invention.

FIGS. 7A and 7B are plan views schematically showing a positional relation between the light sources and the light guide plate, where FIG. 7A shows a positional relation between the light sources and the first light guide plate, and FIG. 7B shows a positional relation between the light sources and the second light guide plate.

FIG. 8 is an exploded perspective view showing a schematic configuration of a display device of a preferred embodiment of the present invention.

### DESCRIPTION OF EMBODIMENTS

Detailed descriptions of preferred embodiments of the present invention will now be provided with reference to the accompanying drawings.

A light source device 1a or a light source device 1b of the preferred embodiments is used for a light source of a display device that includes a transflective or transmissive display panel such as a liquid crystal display device. The light source devices 1a and 1b of the present embodiments define side light source devices, which are referred to also as “side backlight units” or “edge light backlight units”.

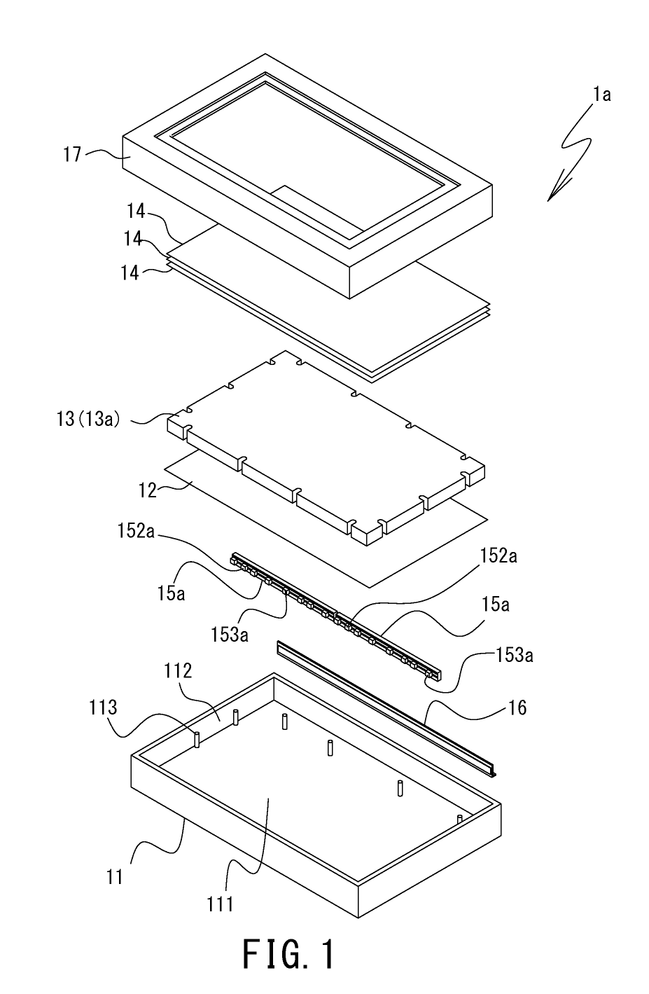

FIG. 1 is an exploded perspective view showing a schematic configuration of a relevant part of the light source device 1a of the first embodiment of the present invention. In FIG. 1, the light source device 1a of the first embodiment and constituent elements thereof are illustrated such that their front faces face toward the top of FIG. 1, and their back faces face toward the bottom of FIG. 1 for the sake of illustration. In addition, a back/forth direction of the light source device 1a of the first embodiment and the constituent elements thereof is referred to as an up/down direction in FIG. 1.

The light source device 1a of the first embodiment includes a chassis 11, a reflection sheet 12, a light guide plate 13 (13a, 13b), optical sheets 14, light sources 15a, a light-source fixing member 16 and a frame 17 as shown in FIG. 1. The light source device 1a of the first embodiment is arranged to guide light emitted by light emitting elements 152a and 153a of the light sources 15a to the light guide plate 13 (13a, 13b) and emit the light to the outside from a front face of the light guide plate 13 (13a, 13b). In other words, the light source device 1a of the first embodiment is arranged to make the light emitted by the light sources 15a into planar light by using the light guide plate 13 (13a, 13b). It is to be noted that the light source device 1a of the first embodiment may include given constituent elements in addition to the constituent elements described above (e.g., an electrical power source arranged to supply power to the light sources 15a), which are not illustrated nor explained.

The chassis 11 defines a housing of the light source device 1a of the first embodiment. The chassis 11 is arranged to house the reflection sheet 12, the light guide plate 13 (13a, 13b), the optical sheets 14, the light sources 15a and the light-source fixing member 16. The chassis 11 has the shape of a dish or tray of low height as shown in FIG. 1. The chassis 11 includes a bottom face 111, and a side wall 112 that surrounds the bottom face 111 and protrudes to the front. The chassis 11 houses the reflection sheet 12, the light guide plate 13 (13a, 13b), the optical sheets 14, the light sources 15a and the light-source fixing member 16 within a region surrounded by the side wall 112 on a front side of the bottom face 111. The chassis 11 is preferably made of a metal plate that is subjected to press working. It is also preferable that the chassis 11 is made of a resin that is subjected to injection molding.

The chassis 11 includes a plurality of locking pins 113 disposed on the bottom face 111 of the chassis 11. The locking pins 113 define structures having a pin shape or a column shape that protrude to the front from the bottom face 111. The locking pins 113 are arranged to engage with locking members (notches 131a, through holes 131b) of the light guide plate 13 (13a, 13b), which allows the light guide plate 13 (13a, 13b) to be disposed on and/or fixed to the bottom face 111 of the chassis 11.

The locking pins 113 are disposed at positions such that the locking pins 113 have no effect on intensity distribution in the plane of the light emitted to the outside on the front side from the light guide plate 13 (13a, 13b). To be specific, the locking pins 113 are disposed on a peripheral portion of the bottom face 111. The shape and size of the locking pins 113 are determined so as to be able to engage with the locking members 131a, 131b of the light guide plate 13 (13a, 13b). To be specific, the shape and size of the locking pins 113 are determined in accordance with the shape and size of the locking members 131a, 131b of the light guide plate 13 (13a, 13b).

The light guide plate 13 (13a, 13b) is arranged to make the light emitted by the light emitting elements 152a and 153a of the light sources 15a into planar light, and then emit the light to the outside from the front face thereof. The light guide plate 13 (13a, 13b) has a plate shape and a given thickness (a size in the back/forth direction). The shape and size of the light guide plate 13 (13a, 13b) are determined in accordance with the shape and size of a display panel of a display device in which the light source device 1a of the first embodiment is included (in particular, the shape and size of a region of the display panel where an image is displayed). To be specific, the shape and size of the light guide plate 13 (13a, 13b) are determined such that the light guide plate 13 (13a, 13b) can project the light onto the entire region of the display panel where an image is displayed. In general, the light guide plate 13 (13a, 13b) has a quadrangular shape with a given aspect ratio.

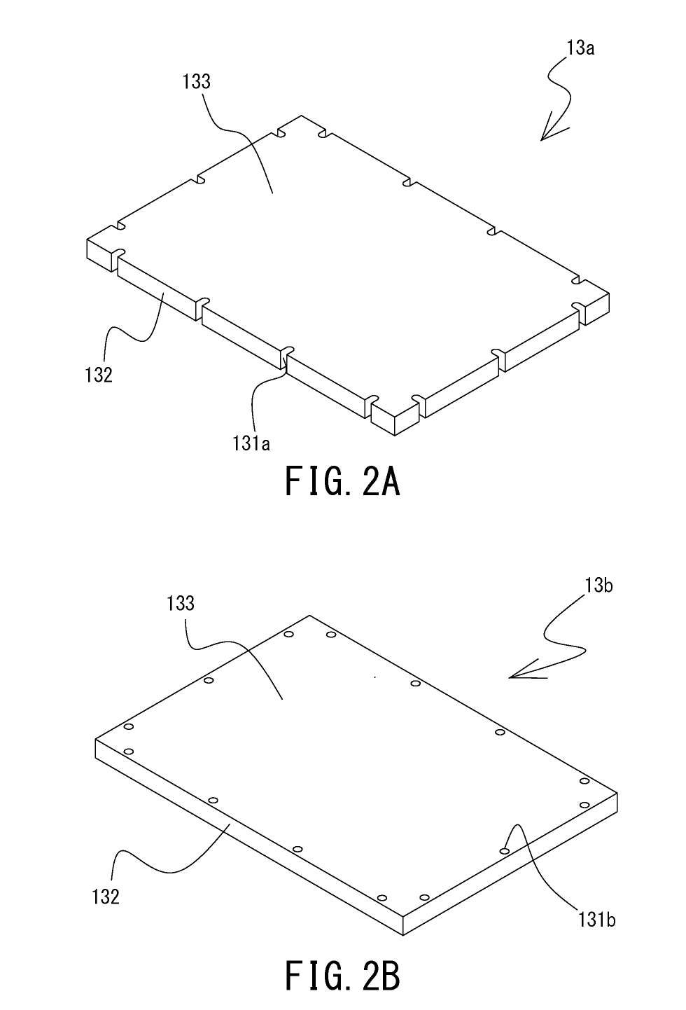

FIGS. 2A and 2B are external perspective views showing schematic configurations of light guide plates 13 (13a, 13b), where FIG. 2A shows the light guide plate 13a including notches that define the locking members 131a, and FIG. 2B shows the light guide plate 13b including through holes (through holes that penetrate in the back/forth direction) that define the locking members 131b. The light guide plate 13a including the notches that define the locking members 131a is referred to as the “first light guide plate”, and the light guide plate 13b including the through holes that define the locking members 131b is referred to as the “second light guide plate” for the sake of illustration. Shown in FIG. 1 is the light source device 1a having the configuration that the first light guide plate 13a is included as an example; however, the light source device 1a may have a configuration that the second light guide plate 13b is included.

The light guide plate 13 (13a, 13b) includes a light incidence face 132 from which the light emitted by the light emitting elements 152a and 153a of the light sources 15a enters, and a light emitting face 133 arranged to emit the light to the outside (to the front). To be specific, because the light guide plate 13 (13a, 13b) has the plate shape and the given thickness, an end face in a plane direction of the plate defines the light incidence face 132, and a face on a front side (one face in a thickness direction) of the light guide plate defines the light emitting face 133.

A face on a back side of the light guide plate 13 (13a, 13b) (a face opposite to the light emitting face 133) has a surface property of easy reflection of light. For example, fine asperities are formed, or a paint that easily reflects light is coated on the face.

The light guide plate 13 (13a, 13b) includes the locking members 131a, 131b disposed on a peripheral portion (end faces in the plane direction) of the light guide plate 13 (13a, 13b) as shown in FIGS. 2A and 2B. When the light guide plate 13 (13a, 13b) is housed in the chassis 11, the locking members 131a, 131b engage with the locking pins 113 on the bottom face 111 of the chassis 11, which can limit the movement of the light guide plate 13 (13a, 13b) (in particular, the movement in the plane direction of the light guide plate 13 (13a, 13b) and the bottom face 111 of the chassis 11).

The position, size and shape of the locking members 131a, 131b are determined so as have no adverse effect on intensity distribution in the plane of the light emitted to the outside (to the front) from the light guide plate 13 (13a, 13b), or determined so as to have little adverse effect on intensity distribution in the plane of the light (e.g., so as not to make intensity distribution in the plane of the light nonuniform). For example, the locking members 131a, 131b are disposed so as not to be seen from the front side through an opening of the frame 17 when the light guide plate 13 (13a, 13b) is attached to the chassis 11 and the frame 17 is attached to the front face thereof. The number, position, size and shape of the locking members 131a, 131b are not limited if the requirements described above are satisfied.

For example, in the first light guide plate 13a, the locking members 131a may be half-round notches as shown in FIG. 2A, or may be square notches or triangular notches. In the second light guide plate 13b, the locking members 131b may be round through holes as shown in FIG. 2B, or may be oval through holes or polygonal through holes.

The locking members 131a, 131b are disposed preferably on the peripheral portion in the plane direction of the light guide plate 13 (13a, 13b) (i.e., disposed at positions so as to have no adverse effect on intensity distribution in the plane of the light emitted from the light source device 1a of the first embodiment). A central portion in the plane direction of the light emitting face 133) of the light guide plate 13 (13a, 13b) is opposed to the back face of the display panel and defines a portion arranged to project the light onto the back face of the display panel when the light source device 1a of the first embodiment is installed in the display device. Thus, it is preferable that the locking members 131a, 131b are disposed outside of the portion opposed to the back face of the display panel (especially outside of the portion opposed to the region of the display panel where an image is displayed). If the light guide plate 13 (13a, 13b) is larger in size than the display panel, the locking members 131a, 131b are consequently disposed on the peripheral portion of the light guide plate 13 (13a, 13b).

The number of the locking members 131a, 131b is not limited. It is essential only that a necessary number of locking members 131a, 131b should be provided for disposition and/or fixing to the chassis 11. When the light guide plate 13 (13a, 13b) has the shape of a quadrilateral, the locking members 131a, 131b are disposed on all of the four sides of the light guide plate 13 (13a, 13b) as shown in FIGS. 2A and 2B. It is also preferable that one locking member 131a, 131b is disposed on some of the four sides of the light guide plate 13 (13a, 13b), or that the locking members 131a, 131b are not disposed on some of the four sides (e.g., not disposed on two opposed sides) of the light guide plate 13 (13a, 13b). The number of the locking members 131a, 131b is determined appropriately in accordance with the size, shape and hardness of the light guide plate 13 (13a, 13b).

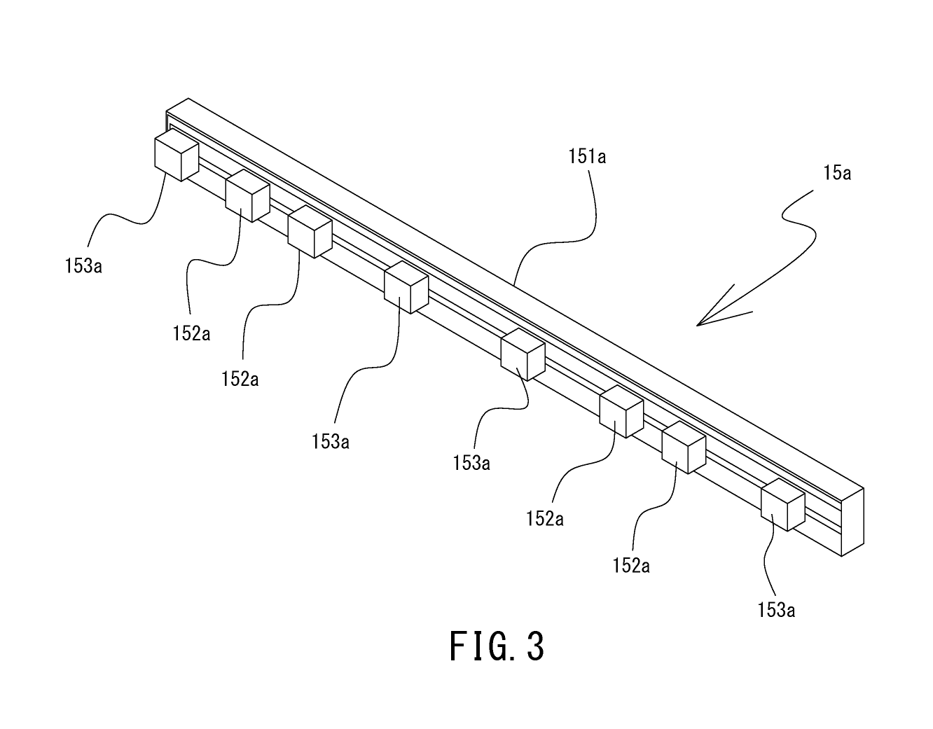

FIG. 3 is an external perspective view showing a schematic configuration of the light source 15a that is used in the light source device 1a of the first embodiment. The light source 15a includes a substrate 151a, and the light emitting elements 152a and 153a that are disposed on one face of the substrate 151a.

The substrate 151a has a long and thin linear shape as shown in FIG. 3. The size in a width direction of the substrate 151a (i.e., the size in the back/forth direction with reference to the light source device 1a of the first embodiment) is determined so as to be housed in the chassis 11. The size in a longitudinal direction of the substrate 151a is determined in accordance with the size of the light incidence face 132 of the light guide plate 13 (13a, 13b) (i.e., the face opposed to the light emitting elements 152a and 153a of the light source 15a). It is preferable that the size in the longitudinal direction of the substrate 151a is same or smaller than the size in the longitudinal direction of the light incidence face 132 of the light guide plate 13 (13a, 13b).

For example, when the size in the longitudinal direction of the substrate 151a is same as the size in the longitudinal direction of the light incidence face 132 of the light guide plate 13 (13a, 13b), one light source 15a can project the light onto the entire region of the light incidence face 132 of the light guide plate 13 (13a, 13b). When the size in the longitudinal direction of the substrate 151a is smaller than the size in the longitudinal direction of the light incidence face 132 of the light guide plate 13 (13a, 13b), a plurality of the aligned light sources 15a can project the light onto the entire region of the light incidence face 132 of the light guide plate 13 (13a, 13b).

Shown in FIG. 1 is the configuration that the two light sources 15a are disposed on one side of the light guide plate 13 (13a, 13b). In other words, the size in the longitudinal direction of the substrate 151a of each light source 15a is determined to be about one-half of the size in the longitudinal direction of the light incidence face 132 of the light guide plate 13 (13a, 13b). The two light sources 15a aligned in series can project the light onto the entire region of the light incidence face 132 of the light guide plate 13 (13a, 13b).

A given wiring pattern and a land (not shown) are provided on the substrate 151a. The light emitting elements 152a and 153a are soldered to be attached to the substrate 151a, and are electrically connected to the land on the substrate 151a. A connector to conduct electric power from the outside may be attached to the substrate 151a, or a wire for the connector may be connected to the substrate 151a (not shown).

The light emitting elements 152a and 153a attached to the substrate 151a are electrically connected in series by the wiring pattern on the substrate 151a. It is preferable that all the light emitting elements 152a and 153a are electrically connected in series. It is also preferable that the light emitting elements 152a and 153a are divided into two groups, and the light emitting elements 152a and 153a in one of the groups are electrically connected in series while the light emitting elements 152a and 153 in the other group are electrically connected in series, and the groups are electrically connected in parallel.

LED packages including LED chips are preferably used as the light emitting elements 152a and 153a. The LED packages have a configuration such that the LED chips are encapsulated in transparent resins, and electrodes arranged to pass an electric current to the LED chips are provided on surfaces of the resins. Because a variety of known LED packages arranged to emit white light are used as the LED packages, a detailed description of the LED packages is not provided.

The light emitting elements 152a and 153a of two kinds that are arranged to emit different kinds of light that are different in intensity are disposed on the substrate 151a of the light source 15a. To be specific, some of the light emitting elements 152a and 153a on the substrate 151a (the light emitting elements referred to as the “light emitting elements 152a”) are arranged to emit light that is higher in intensity than the light emitted by the other light emitting elements (the light emitting elements referred to as the “light emitting elements 153a”). The light emitting elements 152a arranged to emit light that is higher in intensity are referred to as the “high-intensity light emitting elements 152a”, and the light emitting elements 153a arranged to emit light that is lower in intensity are referred to as “low-intensity light emitting elements 153a” for the sake of illustration.

The “high-intensity light emitting elements 152a” and the “low-intensity light emitting elements 153a” include LED packages having configurations to be described below.

In the configuration (1), the LED chips included in the LED packages of the high-intensity light emitting elements 152a are arranged to emit light higher in intensity than the light emitted by the LED chips included in the LED packages of the low-intensity light emitting elements 153a when electric currents of a same value are passed. In other words, the LED chips included in the LED packages of the high-intensity light emitting elements 152a and the LED chips included in the LED packages of the low-intensity light emitting elements 153a are arranged to emit different kinds of light that are different in intensity when electric currents of a same value are passed.

In the configuration (2), the number of LED chips included in the LED packages of the high-intensity light emitting elements 152a and the number of the light emitted by the LED chips included in the LED packages of the low-intensity light emitting elements 153a are different from each other. In other words, the number of LED chips included in the LED packages of the high-intensity light emitting elements 152a is larger than the number of the light emitted by the LED chips included in the LED packages of the low-intensity light emitting elements 153a. For example, the LED package of each high-intensity light emitting element 152a includes two LED chips, and the LED package of each low-intensity light emitting element 153a includes one LED chip. It is essential only that the number of LED chips included in the LED packages of the high-intensity light emitting elements 152a should be larger than the number of the light emitted by the LED chips included in the LED packages of the low-intensity light emitting elements 153a, and the numbers are not limited specifically.

If the light source 15a has the configurations described above, electric currents of a same value can be passed to the light emitting elements 152a and 153a that are electrically connected in series. Thus, the “high-intensity light emitting elements 152a” can emit light higher in intensity than the light emitted by the “low-intensity light emitting elements 153a”.

The light emitting elements 152a and 153a are disposed in series (almost in series) at given intervals in the longitudinal direction of the substrate 151a as shown in FIG. 3. The intervals between the light emitting elements 152a and 153a are not limited specifically. The intervals between the light emitting elements 152a and 153a are determined appropriately in accordance with the intensity of light that the light emitting elements 152a and 153a emit or the specifications of the light source device 1a of the first embodiment (e.g., the intensity of light emitted to the front side). The specific positions of the light emitting elements 152a and 153a, and the arrangement of the high-intensity light emitting elements 152a and the low-intensity light emitting elements 153a are determined based on a relation with the locking members 131a, 131b on the light guide plate (13a, 13b), which is described later.

A description will be provided with reference to FIG. 1 again. The light-source fixing member 16 is arranged to fix the light sources 15a to the chassis 11. The light-source fixing member 16 preferably has the rod-like shape of the letter “L” in cross section as shown in FIG. 1. The light sources are fixed to one side of the letter “L” of the light-source fixing member 16, and the other side of the letter “L” is fixed to the bottom face 111 of the chassis 11, whereby the light sources 15a can be fixed to the chassis 11. It is essential only that the light-source fixing member 16 has a configuration capable of fixing the light sources 15a to the chassis 11, and the configuration is not limited to the configuration shown in FIG. 1. It is also preferable that the light sources 15a are fixed directly to the chassis 11 without using the light-source fixing member 16.

In addition, it is preferable that the light-source fixing member 16 has the function of preventing the light sources 15a from becoming hot by conducting heat generated by the light sources 15a to the chassis 11 (the function of radiating heat of the light sources 15a). In this case, the light-source fixing member 16 and the chassis 11 are preferably made from a material having favorable thermal conductivity. For example, the light-source fixing member 16 and the chassis 11 are made from metal such as aluminum.

The reflection sheet 12 is arranged to reflect to return the light that leaks out of the back face of the light guide plate 13 (13a, 13b). For example, the reflection sheet 12 defines a white sheet made of a resin. For example, a sheet of an expanded PET (polyethylene terephthalate) that is about 0.1 to 2 mm in thickness is preferably used as the reflection sheet 12. Because the reflection sheet 12 reflects to return the light that leaks out of the back face of the light guide plate 13 (13a, 13b), the light can be used effectively (waste of the light can be reduced). The material and thickness of the reflection sheet 12 are not limited specifically.

The optical sheets 14 define optical members having the shape of a plate, sheet or film, which are arranged to adjust the properties of light that passes therethrough. For example, a diffusion plate, a diffusion film (or a diffusion sheet), a lens film (or a lens sheet) and a luminance enhancement sheet are used for the optical sheets 14.

The diffusion plate defines an optical member arranged to randomly diffuse light that passes therethrough, allowing uniformalization of brightness distribution in a plane direction of the light. The diffusion plate is made from a nearly clear resin material that is a base material, in which fine particles having a surface property of reflecting light, or fine particles made of a material having a refractive index different from the base material are mixed.

The diffusion film or sheet defines an optical member that allows uniformalization of intensity distribution in a plane direction of the light that passes therethrough. The diffusion film or sheet is made from a clear base material, in which fine particles having a surface property of reflecting light, or fine particles made of a material having a refractive index different from the base material are mixed, and formed into a film or sheet shape. The lens film or sheet defines an optical member arranged to gather light that passes there through, allowing enhancement of brightness of the light. The lens film or sheet has a layer structure made up of a nearly clear base layer, and a layer of a given cross-sectional shape that has a light-gathering function. The base layer is preferably made from a resin such as PET. The layer having the light-gathering function is preferably made from an acrylic resin. The luminance enhancement film defines an optical member arranged to effectively use the light the light sources emit, allowing enhancement of brightness of the image screen displayed by a display panel 511 of a display device 5 of a preferred embodiment of the present invention (to be described later). The luminance enhancement film is capable of transmitting the light having a polarization axis in a given direction and reflecting the other light. The luminance enhancement film is preferably a DBEF film (DBEF is a registered trademark of 3M COMPANY).

The optical sheets 14 of given kinds are stacked in a given order. The number and the kinds of the optical sheets 14 included in the light source device 1a of the first embodiment are not limited specifically. The number and the kinds of the optical sheets 14 are determined appropriately in accordance with the kind of the light source device 1a of the first embodiment, or the kind of the display device 5 in which the light source device 1a of the first embodiment is included (i.e., the display device 5 of the preferred embodiment of the present invention).

The frame 17 defines, together with the chassis 11, a portion of a housing of the light source device 1a of the first embodiment. The frame 17 is arranged to hold the reflection sheet 12, the light guide plate 13 (13a, 13b) and the optical sheets 14 in the chassis 11 (i.e., arranged to make them not to fall from the chassis 11). The frame 17 has the shape of a square with an opening capable of transmitting light. The frame 17 is preferably made of a metal plate that is subjected to press working. It is also preferable that the frame 17 is made of a resin that is subjected to injection molding. The size and shape of the frame 17 (in particular, the size and shape of the opening) are determined appropriately in accordance with the specifications of the light source device 1a of the first embodiment (e.g., the size of a screen of a display device in which the light source device 1a of the first embodiment is included). The configuration of the frame 17 is not limited specifically as described above.

Next, a description of assembly of the light source device 1a of the first embodiment will be provided with reference to FIG. 1.

The light-source fixing member 16 is fixed to the bottom face 111 of the chassis 11. The light sources 15a are fixed to the light-source fixing member 16.

Shown in FIG. 1 is the configuration that the two light sources 15a are disposed on one side of the light guide plate 13 (13a, 13b); however, the present invention is not limited to this configuration. It is also preferable that light sources are provided on a plurality of sides of the light guide plate 13 (13a, 13b). When the light guide plate 13 (13a, 13b) has the shape of a quadrilateral, the light sources 15a are disposed preferably on two opposed sides among the four sides, or preferably on all of the four sides. In addition, the number of the light sources 15a that are disposed on one side of the light guide plate 13 (13a, 13b) is not limited specifically. It is preferable that the two light sources 15a are disposed on one side of the light guide plate (13a, 13b) as shown in FIG. 1; however, it is also preferable that the one light source 15a is disposed on one side, or it is also preferable that three or more light source 15a re disposed on one side.

The reflection sheet 12 is placed on the bottom face 111 of the chassis 11, and the light guide plate 13 (13a, 13b) is further placed on the front face of the reflection sheet 12. When the light guide plate 13 (13a, 13b) is placed on the bottom face 111 of the chassis 11, the locking members (the notches 131a or through holes 131b) of the light guide plate 13 (13a, 13b) engage with the locking pins 113 disposed on the bottom face 111 of the chassis 11, whereby the light guide plate 13 (13a, 13b) is disposed on and fixed to the chassis 11 (alternatively, it is also preferable that the light guide plate 13 (13a, 13b) is disposed on the chassis 11, or it is also preferable that the light guide plate 13 (13a, 13b) is fixed to the chassis 11).

These configurations limit the movement of the light guide plate 13 (13a, 13b) (in particular, the movement in the plane direction of the light guide plate 13 (13a, 13b) and the bottom face 111 of the chassis 11). Consequently, the light emitting elements 152a and 153a can be prevented from being broken because of the light sources 15's contacting with the light guide plate 13 (13a, 13b).

The optical sheets 14 are placed on the front face of the light guide plate 13 (13a, 13b), and the frame 17 is attached to the chassis 11 from the front side of the optical sheets 14. When the frame 17 is attached to the chassis 11, the reflection sheet 12, the light guide plate 13 (13a, 13b) and the optical sheets 14 are kept being housed in the chassis 11. The locking members 131a, 131b of the light guide plate 13 (13a, 13b) and the locking pins 113 of the bottom face 111 of the chassis 11 are not seen from the front side because they are hidden by frame 17.

An electrical power source (e.g., a circuit board 27 that incorporates a power supply circuit) arranged to supply power to the light sources 15a is preferably provided on the back face of the light source device 1a of the first embodiment (the back face of the bottom face 111 of the chassis 11). Other constituent elements (not shown) are preferably provided to the chassis 11. Explanations thereof are not provided.

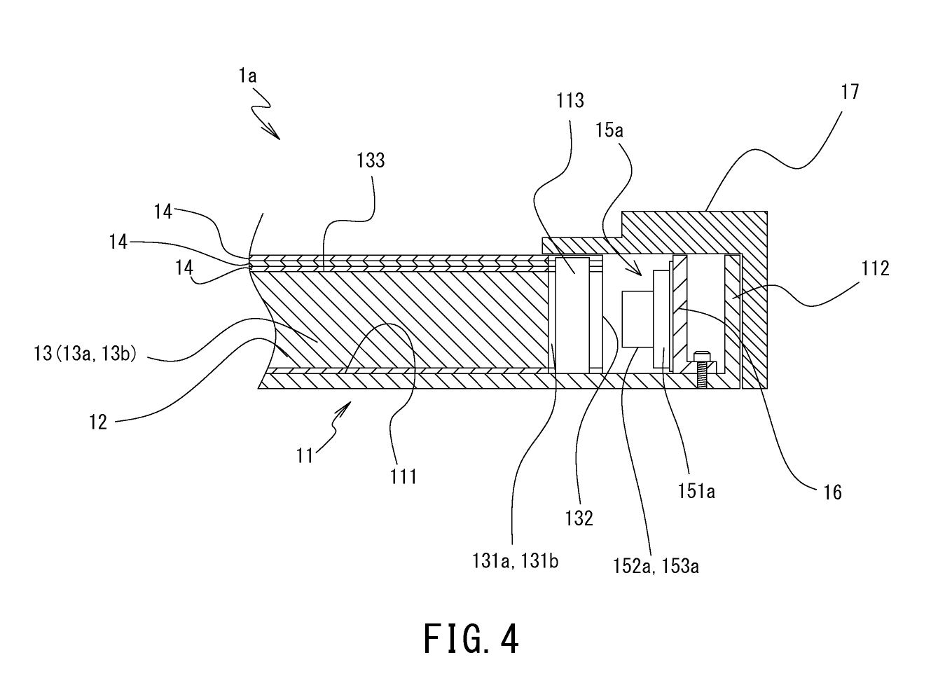

FIG. 4 is a cross-sectional view schematically showing a portion of an inner structure of the light source device 1a of the first embodiment, and showing in particular a relation between the light sources 15a and the light guide plate 13 (13a, 13b).

When the light sources 15a, the light-source fixing member 16 and the light guide plate 13 (13a, 13b) are housed in the chassis 11, the light emitting elements 152a and 153a disposed on the substrates 151a of the light sources 15a are opposed to the light incidence face 132 (the end face in the plane direction) of the light guide plate 13 (13a, 13b) as shown in FIG. 4. Thus, the light the light emitting elements 152a and 153a emit is guided to the inside of the light guide plate 13 (13a, 13b) from the light incidence face 132.

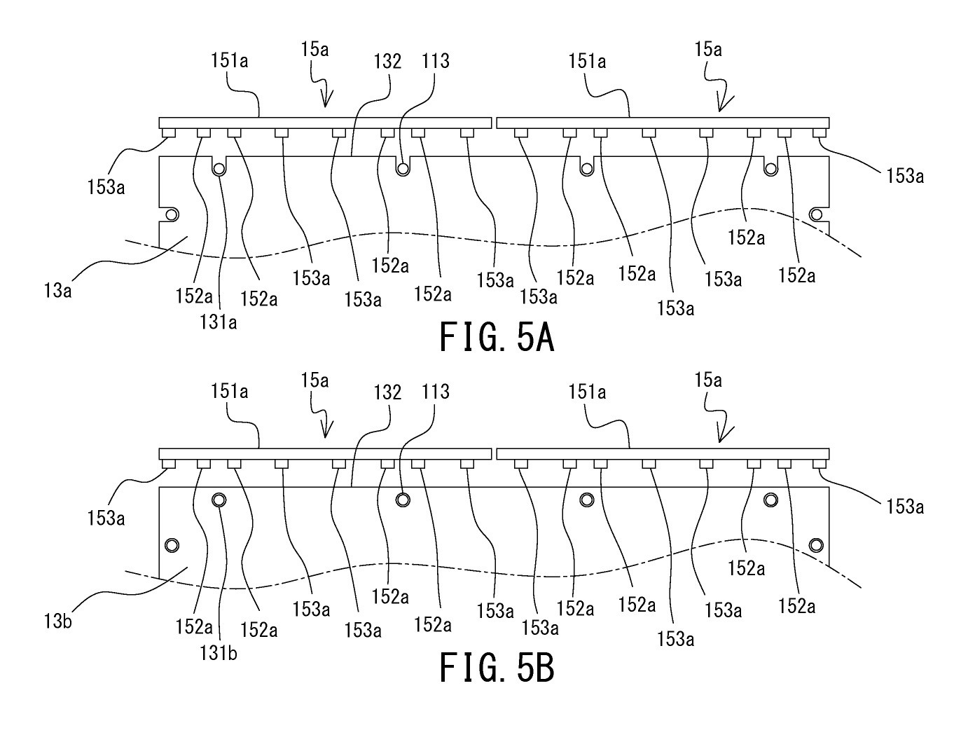

The light emitting elements 152a and 153a of the light sources 15a and the locking members 131a, 131b of the light guide plate 13 (13a, 13b) (and the locking pins 113 of the chassis 11) seem to be opposed to each other in FIG. 4; however, they are not opposed to each other actually when the light source device 1a of the first embodiment is seen from the front side. In other words, the light emitting elements 152a and 153a of the light sources 15a are not disposed outside of the locking members 131a, 131b of the light guide plate 13 (13a, 13b) (see FIG. 5).

Then, the light guided to the inside of the light guide plate 13 (13a, 13b) travels inside of the light guide plate 13 (13a, 13b) while reflected on a face on the back side of the light guide plate 13 (13a, 13b), and is emitted to the outside from the light emitting face 133 (the face on the front side). The light emitted from the light guide plate 13 (13a, 13b) passes through the optical sheets 14, whereby the properties of the light is adjusted. Then, the light of which the properties are adjusted is emitted to the outside from the front side of the light source device 1a of the first embodiment.

FIGS. 5A and 5B are plan views schematically showing a positional relation between the light sources 15a and the light guide plate 13 (13a, 13b), where FIG. 5A shows a positional relation between the light sources 15a and the first light guide plate 13a, and FIG. 5B shows a positional relation between the light sources 15a and the second light guide plate 13b. When the light-source fixing member 16 to which the light sources 15a are attached is fixed to the bottom face 111 of the chassis 11, and the light guide plate 13 (13a, 13b) is disposed (housed) on the bottom face 111 of the chassis 11, the light emitting elements 152a and 153a disposed on the substrates 151a of the light sources 15a are opposed to the light incidence face 132 (the end face in the plane direction) of the light guide plate 13 (13a, 13b) as shown in FIGS. 5A and 5B.

The light emitting elements 152a and 153a on the substrates 151a of the light sources 15a are not disposed at positions opposed to the locking members 131a, 131b of the light guide plate 13 (13a, 13b). The high-intensity light emitting elements 152a are disposed at positions other than the positions opposed to the locking members 131a, 131b of the light guide plate 13 (13a, 13b), i.e., disposed at positions opposed to the portions in the vicinity (close vicinity) of the locking members 131a, 131b. The low-intensity light emitting elements 153a are disposed at other portions. To be specific, among the light emitting elements 152a and 153a disposed on the substrates 151a of the light sources 15a, the light emitting elements disposed at positions closest to the positions opposed to the locking members 131a, 131b of the light guide plate 13 (13a, 13b) are the high-intensity light emitting elements 152a, and the other light emitting elements are the low-intensity light emitting elements 153a.

As described above, the positions and the kinds of the light emitting elements 152a and 153a disposed on the substrates 151a of the light sources 15a (i.e., the positions where the high-intensity light emitting elements 152a are disposed and the positions where the low-intensity light emitting elements 153a are disposed) are determined based on the relation with the locking members 131a, 131b of the light guide plate 13 (13a, 13b) in a state where the light guide plate 13 (13a, 13b) and the light sources 15a are attached to (housed in) the chassis 11.

As described above, the light source device 1a of the first embodiment includes the light guide plate 13 (13a, 13b) including the locking members 131a, 131b for disposition and/or fixing that are disposed on a peripheral portion of the light guide plate 13 (13a, 13b) (i.e., the peripheral portion defines the light incidence face 132 (the end face in the plane direction)) or disposed in the vicinity of the peripheral portion, and includes the light emitting elements 152a and 153a that are capable of projecting light onto the peripheral portion of the light guide plate 13 (13a, 13b). The light emitting elements disposed at the positions in the vicinity of the locking members 131a, 131b of the light guide plate 13 (13a, 13b) (i.e., disposed at the positions opposed to the portions in the vicinity of the locking members 131a, 131b of the light guide plate 13 (13a, 13b)) are the high-intensity light emitting elements 152a, which project light that is higher in intensity than the light that is projected by the other light emitting elements (the low-intensity light emitting elements 153a). Consequently, the intensity of the light projected onto the portions in the vicinity of the locking members 131a, 131b on the peripheral portion of the light guide plate 13 (13a, 13b) is higher than the intensity of the light projected onto the other portions.

The light source device 1a of the first embodiment has the following action and effect.

Because the intensity of the light projected onto the portions in vicinity of the locking members 131a, 131b on the peripheral portion of the light guide plate 13 (13a, 13b) is higher than the intensity of the light projected onto the other portions, the amount of the light that is guided to the portions in the vicinity of the locking members 131a, 131b disposed on the peripheral portion of the light guide plate 13 (13a, 13b) (the amount of the light that is guided to the inside of the light guide plate 13 (13a, 13b) from the portions in the vicinity of the locking members 131a, 131b) can be increased compared with the amount of the light that is guided to the other portions. Thus, a decrease in intensity of the light that is emitted to the front from the portions in the vicinity of the locking members 131a, 131b) can be minimized or prevented. Consequently, intensity distribution in the plane of the light emitted from the light emitting face 133 (the face on the front side) of the light guide plate 13 (13a, 13b) can be made uniform (or, non-uniformalization can be minimized or prevented).

In other words, if the light sources 15a have a configuration of emitting, as a whole, light that is uniform (e.g., if the light emitting elements 152a and 153a are disposed at almost regular or regular intervals on the substrates 151a of the light sources 15a), a problem as described below arises.

In the configuration that the first light guide plate 13a is used, the light emitted by the light emitting elements 152a and 153a disposed outside of the locking members 131a of the first light guide plate 13a is hampered by the locking members 131a of the first light guide plate 13a, and cannot be guided to the inside of the first light guide plate 13a. In the configuration that the second light guide plate 13b is used, the light emitted by the light emitting elements 152a and 153a disposed outside of the locking members 131b is guided to the inside of the second light guide plate 13b but cannot travel toward the center in the plane direction of the second light guide plate 13b because the light is hampered by the locking members 131b. Thus, in both of the configurations that the first light guide plate 13a and the second light guide plate 13b are used, the amount of the light guided to more inside of the locking members 131a, 131b decreases compared with the amount of the light that is guided to the other portions, which makes intensity distribution in the plane of the light that is emitted from the light emitting face 133 of the light guide plate 13 (13a, 13b) nonuniform. To be specific, the portions inside of the locking members 131a, 131b (the portions inside of the locking pins 113 of the chassis 11) are darker than the other portions.

Contrary to these configurations, the light source device 1a of the first embodiment, which has an action described below, allows intensity distribution in the plane of the light emitted from the light emitting face 133 of the light guide plate 13 (13a, 13b) uniform.

Because the intensity of the light projected onto the portions in vicinity of the locking members 131a, 131b on the peripheral portion of the light guide plate 13 (13a, 13b) is higher than the intensity of the light projected onto the other portions, the amount of the light that is guided to the portions in the vicinity of the locking members 131a, 131b disposed on the peripheral portion of the light guide plate 13 (13a, 13b) (the amount of the light that is guided to the inside of the light guide plate 13 (13a, 13b) from the portions in the vicinity of the locking members 131a, 131b) can be increased compared with the amount of the light that is guided to the other portions. Thus, a decrease in intensity of the light that is emitted to the outside from the portions in the vicinity of the locking members 131a, 131b (in particular, from the portions in the vicinity of the inside of the locking members 131a, 131b in the plane direction) can be minimized or prevented. Consequently, intensity distribution in the plane of the light emitted from the light emitting face 133 of the light guide plate 13 (13a, 13b) can be made uniform (or, non-uniformalization can be minimized or prevented).

In other words, the amount of the light that is guided to the inside of the light guide plate 13 (13a, 13b) from the portions in the vicinity of the locking members 131a, 131b can be made equal to the amount of the light that is guided to the inside of the light guide plate 13 (13a, 13b) from the other portions. The light emitted by the light emitting elements 152a and 153a of the light sources 15a is not guided to the inside of the light guide plate 13 (13a, 13b) via the locking members 131a, 131b. However, the light that is higher in intensity than the other portions is guided to the portions in the vicinity of the locking members 131a, 131b, which can compensate for the amount of the light “that should have been guided if the locking members 131a, 131b were not provided”. Thus, decrease in intensity of the light that is emitted to the front from the portions in the vicinity of the locking members 131a, 131b can be minimized or prevented compared with the light that is guided to the front from the other portions, which can make intensity distribution in the plane of the light emitted from the light emitting face 133 of the light guide plate 13 (13a, 13b) uniform (or, non-uniformalization can be minimized or prevented).

Because the light emitting elements 152a and 153a are not disposed outside of the locking members 131a, 131b of the light guide plate 13 (13a, 13b), the light is not projected onto the locking members 131a, 131b. That is, needless light emitting elements 152a and 153a do not exist. Consequently, use efficiency of the light can be increased (or, use efficiency of the light can be prevented from decreasing).

The light guide plate 13 (13a, 13b) is disposed on and/or fixed to the chassis 11 of the light source device 1a of the first embodiment because the locking pins 113 of the chassis 11 engage with the locking members 131a, 131b of the light guide plate 13 (13a, 13b). Thus, the light guide plate 13 (13a, 13b) can be firmly in a convincing way disposed on and/or fixed to the chassis 11 compared with the configuration that the light guide plate 13 (13a, 13b) is fixed to the chassis 11 using a double-faced tape, which can maintain intensity distribution in the plane of the light emitted from the light emitting face 133 of the light guide plate 13 (13a, 13b) uniform (or, non-uniformalization can be minimized or prevented) while allowing the light guide plate 13 (13a, 13b) to be firmly in a convincing way disposed on and/or fixed to the chassis 11.

It is unnecessary to provide a protrusion for disposition and/or fixation on the peripheral portion of the light guide plate 13 (13a, 13b), so that the position or the structure of the light sources 15a is not limited thereby. Thus, the light sources 15a can be disposed on the entire peripheral portion of the light guide plate (13a, 13b) (i.e., the light emitting elements 152a and 153a can be disposed around the entire perimeter of the light guide plate 13 (13a, 13b)). This configuration can maintain intensity distribution in the plane of the light, the light source device 1a of the first embodiment emits, uniform while facilitating adjustment of the amount of the light.

To be specific, because it is unnecessary to provide a protrusion on the peripheral portion of the light guide plate 13 (13a, 13b), the outer shape of the light guide plate 13 (13a, 13b) (i.e., the shape of the peripheral portion of the light guide plate 13 (13a, 13b)) can be simplified, which can thus simplify the structure or shape of the light sources 15a disposed on the peripheral portion of the light guide plate 13 (13a, 13b) (or, complexity can be minimized or prevented). In this configuration, it is easy to design or set a clearance between the peripheral portion of the light guide plate 13 (13a, 13b) and the light sources 15a, which is provided as a measure against thermal expansion of the light guide plate 13 (13a, 13b). In addition, because the peripheral portion of the light guide plate 13 (13a, 13b) has a simple shape (e.g., a linear shape), the clearance between the peripheral portion of the light guide plate 13 (13a, 13b) and the light sources 15a is made uniform easily. Thus, the amount of the light that is guided to the light guide plate 13 (13a, 13b) can be made uniform easily.

A description of a light source device 1b of a second embodiment of the present invention will now be provided. The light source device 1a of the first embodiment and the light source device 1b of the second embodiment are different from each other because the configurations of the light sources used therein are different from each other while the other configurations are common. Thus, explanations of the constituent elements of the light source device 1b of the second embodiment that are common to the light source device 1a of the first embodiment are omitted, and different respects are explained mainly, providing the same reference numerals as those of the light source device 1a of the first embodiment to the constituent elements of the light source device 1b of the second embodiment that are common to the light source device 1a of the first embodiment.

The light source device 1b of the second embodiment includes the chassis 11, the reflection sheet 12, the light guide plate 13 (13a, 13b), the optical sheets 14, light sources 15b, the light-source fixing member 16 and the frame 17. The chassis 11, the reflection sheet 12, the light guide plate 13 (13a, 13b), the optical sheets 14, the light-source fixing member 16 and the frame 17 are same as the ones used in the light source device 1a of the first embodiment, so that explanations thereof are not provided.

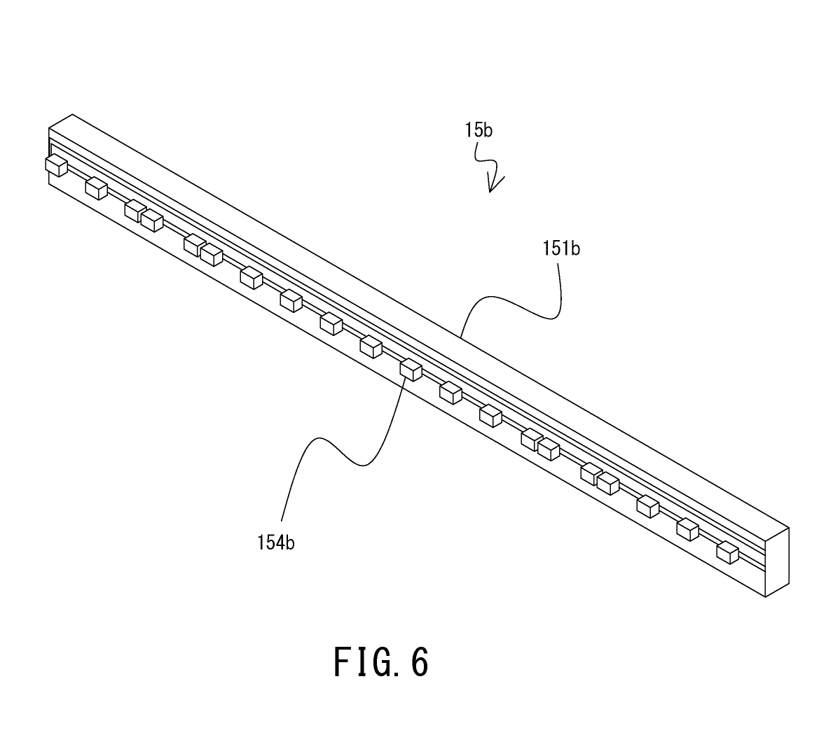

FIG. 6 is an external perspective view showing a schematic configuration of the light source 15b that is used in the light source device 1b of the second embodiment. The light source 15b includes a substrate 151b, and a plurality of light emitting elements 154b that are disposed on one face of the substrate 151b.

The substrate 151b has a long and thin linear shape as shown in FIG. 6. The shape and size of the substrate 151b can be made same as the shape and size of the substrate 151a. A wiring pattern and a land (not shown) provided on the substrate 151b may have the same configurations as the wiring pattern and the land of the substrate 151a of the light source 15a of the light source device 1a of the first embodiment, though the light emitting elements 154b are different in kind, number and position. In addition, other constituent elements of the substrate 15b may have the same configurations as the corresponding constituent elements of the substrate 151a of the light source 15a of the light source device 1a of the first embodiment. Further, the relation between the shape and size of the substrate 151b and the installation conditions (the number and arrangement) of the substrate 151b are same as the relation in the light source device 1a of the first embodiment.

LED packages including LED chips are preferably used as the light emitting elements 154b. The LED packages have a configuration such that the LED chips are encapsulated in transparent resins, and electrodes arranged to pass an electric current to the LED chips are provided on surfaces of the resins. Because a variety of known LED packages arranged to emit white light are used as the LED packages, a detailed description of the LED packages is not provided.

The light emitting elements 154b are disposed in series (almost in series) at given intervals in a longitudinal direction of the substrate 151b. Some of the intervals between the light emitting elements 154b are shorter than the others. To be specific, the light emitting elements 154b, which are disposed at regions opposed to the portions in the vicinity of the locking members 131a, 131b of the light guide plate 13 (13a, 13b), are disposed at a higher density than the light emitting elements 154b disposed at the other regions in a state where the light sources 15b are attached to the light source device 1b of the second embodiment. Further, no light emitting elements 154b are disposed at regions opposed to the locking members 131a, 131b of the light guide plate 13 (13a, 13b). Thus, the specific positions of the light emitting elements 154b are determined based on a relation with the locking members 131a, 131b on the light guide plate 13 (13a, 13b), which is described later.

The number of light emitting elements 154b provided on each substrate 151b is not limited specifically. In addition, the specific intervals between the light emitting elements 154b are not limited specifically. The number and specific intervals are determined appropriately in accordance with the intensity of light that the light emitting elements 154b emit the specifications of the light source device 1b of the second embodiment (e.g., the intensity of light emitted to the front side).

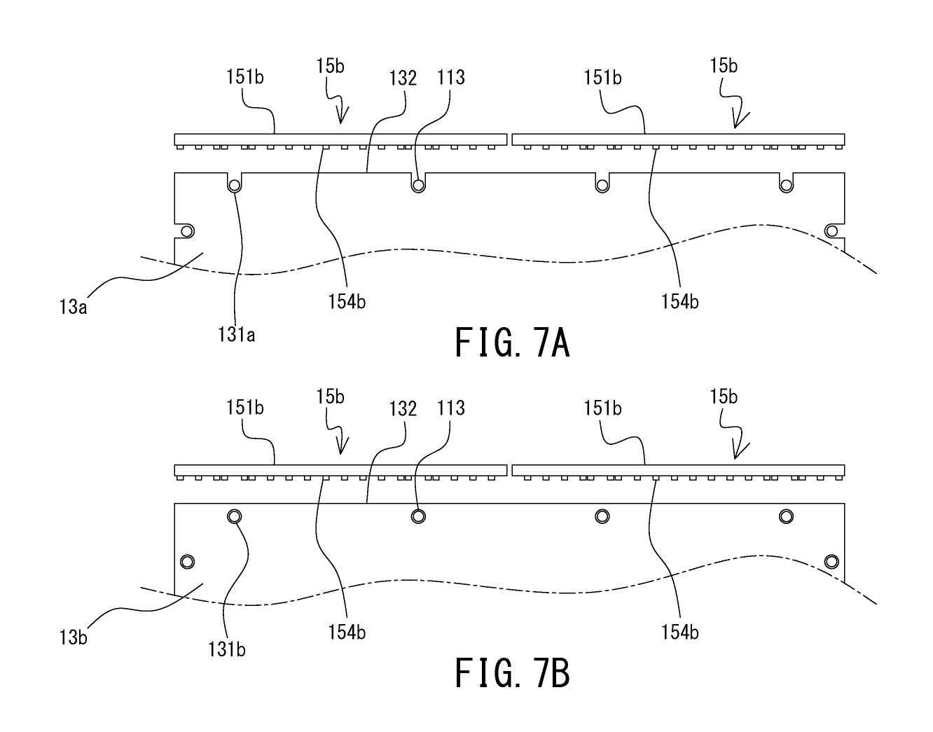

FIGS. 7A and 7B are plan views schematically showing a positional relation between the light sources 15b and the light guide plate 13 (13a, 13b), where FIG. 7A shows a positional relation between the light sources 15b and the first light guide plate 13a, and FIG. 7B shows a positional relation between the light sources 15b and the second light guide plate 13b. When the light-source fixing member 16 to which the light sources 15b are attached is fixed to the bottom face 111 of the chassis 11, and the light guide plate 13 (13a, 13b) is disposed (housed) on the bottom face 111 of the chassis 11, the light emitting elements 154b disposed on the substrates 151b of the light sources 15b are opposed to the light incidence face 132 (the end face in the plane direction) of the light guide plate 13 (13a, 13b) as shown in FIGS. 7A and 7B.

The light emitting elements 154b on the substrates 151b of the light sources 15b are not disposed at positions opposed to the locking members 131a, 131b of the light guide plate 13 (13a, 13b). The light emitting elements 154b, which are disposed at positions other than the positions opposed to the locking members 131a, 131b of the light guide plate 13 (13a, 13b), i.e., disposed at positions opposed to the portions in the vicinity (close vicinity) of the locking members 131a, 131b, are disposed at smaller intervals (i.e., at a higher density) than the light emitting elements 154b disposed at the other positions.

As described above, the positions of the light emitting elements 154b disposed on the substrates 151b of the light sources 15b (i.e., the intervals between the light emitting elements 154b, and the density at which the light emitting elements 154b are disposed) are determined based on the relation with the positions of the locking members 131a, 131b of the light guide plate 13 (13a, 13b) (i.e., the positions of the locking pins 113 of the chassis 11) in a state where the light sources 15b are attached to (housed in) the chassis 11.

The light emitting elements 154b disposed on the substrates 151b are arranged to emit light that is equal to one another in intensity (i.e., the light emitting elements 154b having the same properties) when electric currents of a same value are passed. It is also preferable to use the light emitting elements 154b that have different properties. It is essential that the intensity of the light emitted from the regions where the intervals between the light emitting elements 154b are smaller among the light emitted from the light sources 15b should be higher than the intensity of the light emitted from the other regions. In other words, it is essential only that the intensity of the light emitted from the light sources 15b should be almost uniform except for the regions where the light emitting elements 154b are disposed at a higher density, and that the intensity of the light emitted from the regions where the light emitting elements 154b are disposed at a higher density should be higher than the intensity of the light emitted from the other regions.

Thus, it is also preferable that “the high-intensity light emitting elements 152a” of the light sources 15a of the light source device 1a of the first embodiment are used at the regions where the intervals between the light emitting elements 154b are smaller while “the low-intensity light emitting elements 153a” are used at the other regions.

It is preferable that the intensity of the light emitted from the light sources 15b should be almost uniform at the regions except for the regions where the intervals between the light emitting elements 154b are smaller. For example, the light emitting elements 154b having same properties are disposed at regular intervals at the regions except for the regions where the intervals between the light emitting elements 154b are smaller.

As described above, the light source device 1b of the second embodiment includes the light guide plate 13 (13a, 13b) including the locking members 131a, 131b for disposition and/or fixing that are disposed on a peripheral portion of the light guide plate 13 (13a, 13b) (i.e., the peripheral portion defines the light incidence face 132 (the end face in the plane direction)) or disposed in the vicinity of the peripheral portion, and includes the light emitting elements 154b that are capable of projecting light onto the peripheral portion of the light guide plate 13 (13a, 13b). The intensity of the light is higher at some regions of the light sources 15b, the regions at which the light is projected onto the portions in the vicinity of the locking members 131a, 131b because the light emitting elements 154b are disposed at smaller intervals at the regions than the light emitting elements 154b disposed at the other regions. Consequently, the intensity of the light projected onto the portions in the vicinity of the locking members 131a, 131b on the peripheral portion of the light guide plate 13 (13a, 13b) is higher than the intensity of the light projected onto the other portions.

The light source device 1b of the second embodiment has the same action and effect as the light source device 1a of the first embodiment.

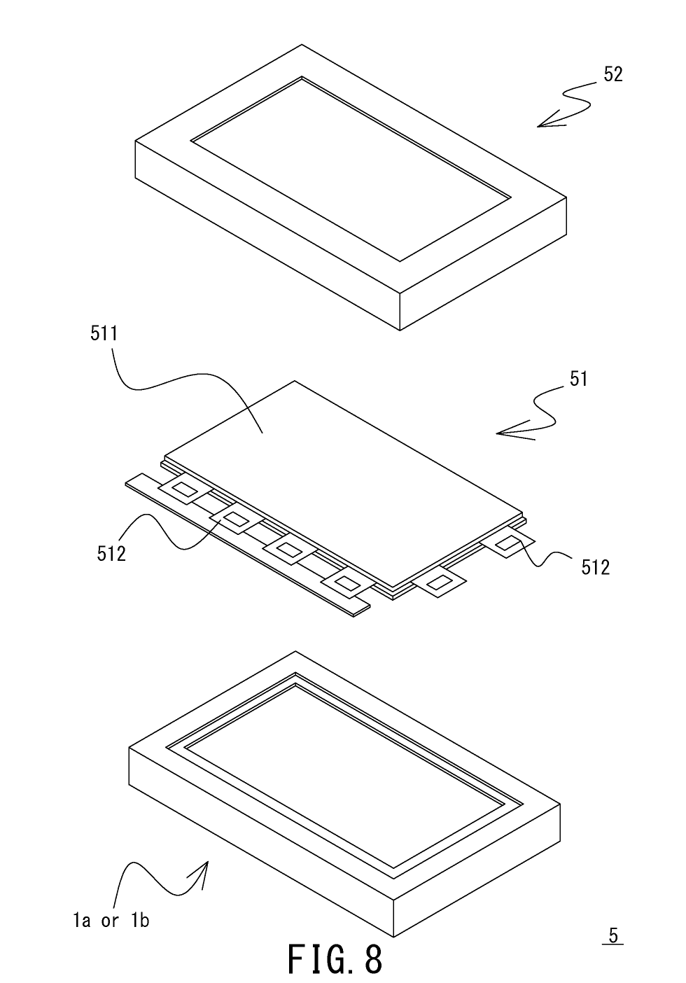

Next, a detailed description of the display device 5 of a preferred embodiment of the present invention will be provided. FIG. 8 is an exploded perspective view showing a schematic configuration of the display device 5 of the present embodiment. The display device 5 of the present embodiment includes the light source device 1a of the first embodiment or the light source device 1b of the second embodiment, a display panel assembly 51, and a bezel 52 as shown in FIG. 8. In addition, the display device 5 preferably includes a control circuit board arranged to control the display panel assembly 51 (not shown). In FIG. 8, the display device 5 of the present embodiment and constituent elements thereof are illustrated such that their front faces face toward the top of FIG. 8, and their back faces face toward the bottom of FIG. 8 for the sake of illustration.

The display panel assembly 51 includes the display panel 511, and circuit boards 512 arranged to drive the display panel 511. The display panel assembly 51 has a configuration such that the circuit boards 512 are attached to the display panel 511. A variety of conventional transmissive or transflective liquid crystal display panels can be used for the display panel 511. For example, a variety of conventional transmissive or transflective active matrix liquid crystal display panel can be used. If an active matrix liquid crystal display panel is used as the display panel 511, film circuit boards (e.g., FPC), which incorporate driver ICs (or driver LSIs, generally referred to as “gate drives” and “source drivers”) arranged to generate signals to drive switching elements provided to the display panel 511, are prefer ably used as the circuit boards 512. The circuit boards 512 preferably have a conventional configuration. Thus, descriptions thereof are not provided.

The bezel 52 has the function of keeping the display panel assembly 51 to be attached to the light source device 1a of the first embodiment or the light source device 1b of the second embodiment, and the function of protecting the display panel assembly 51. The bezel 52 has a frame shape with an opening from which at least a part of a front face of the display panel 511 (a region of the display panel 511 where an image is displayed) can be seen from the front. The bezel 52 is preferably made of a metal plate that is subjected to press working. It is also preferable that the bezel 52 is made of a resin that is subjected to injection molding. The size and shape of the bezel 52 (in particular, the size and shape of the opening) are determined appropriately in accordance with the size and shape of the display panel 511. The configuration of the bezel 52 is not limited specifically as described above.

The display device 5 of the present embodiment may further include a circuit board and other constituent elements that are arranged to generate signals to drive the display panel assembly 51 (not shown).

Next, a description of assembly of the display device 5 of the present embodiment will be provided. The display panel assembly 51 is disposed on the front face of the light source device 1a of the first embodiment or the light source device 1b of the second embodiment (the front face of the chassis 11). Then, the bezel 52 is disposed on the front face of the display panel assembly 51 and attached to the chassis 11. In this configuration, the display panel assembly 51 is held between the light source device 1a of the first embodiment or the light source device 1b of the second embodiment and the bezel 52. Then, at least apart of the front face of the display panel 511 (at least the region where an image is displayed) can be seen from the front through the opening of the bezel 52.

In the display device 5 of the present embodiment, the light emitted from the light source device 1a of the first embodiment or the light source device 1b of the second embodiment is projected onto the back face of the display panel 511. Then, the display panel 511 transmits the projected light, whereby an image is displayed visible on the front face of the display panel 511.

Because the display device 5 of the present embodiment has the configuration that intensity distribution in the plane of the light projected onto the back face of the display panel 511 is uniform, development of luminance unevenness in the image displayed in the display panel 511 can be minimized or prevented. Thus, the display device 5 of the present embodiment has excellent image display quality.

The foregoing description of the preferred embodiments of the present invention has been presented for purposes of illustration and description with reference to the drawings. However, it is not intended to limit the present invention to the embodiments, and modifications and variations are possible as long as they do not deviate from the principles of the present invention.

1. A light source device comprising:
a light guide plate comprising a locking member for disposition and fixing that is disposed on a peripheral portion of the light guide plate, or disposed in a vicinity of the peripheral portion; and
a plurality of light emitting elements that are capable of projecting light onto the peripheral portion of the light guide plate,
wherein the light that is projected from some of the light emitting elements onto portions of the light guiding plate, the portions being in a vicinity of the locking member, is higher in intensity than the light that is projected from the other light emitting elements onto the other portions of the light guiding plate.

2. The light source device according to claim 1,
wherein the plurality of light emitting elements are disposed along the peripheral portion of the light guide plate, and
wherein the light emitted by the light emitting elements in the vicinity of the locking member disposed on the peripheral portion of the light guide plate is higher in intensity than the light that is emitted by the other light emitting elements.

3. The light source device according to claim 2,
wherein the plurality of light emitting elements comprise LED packages, and
wherein the number of LED chips that the light emitting elements in the vicinity of the locking member disposed on the peripheral portion of the light guide plate comprise is larger than the number of LED chips that the other light emitting elements comprise.

4. The light source device according to claim 1,
wherein the light emitting elements are arranged to emit different kinds of light that are different in intensity,
wherein the light emitting elements that emit light higher in intensity are disposed to be able to project the light onto the portions in the vicinity of the locking member disposed on the peripheral portion of the light guide plate, and
wherein the light emitting elements that emit light lower in intensity are disposed to be able to project the light onto the other portions of the light guide plate.

5. The light source device according to claim 4,
wherein the plurality of light emitting elements comprise LED packages, and
wherein the number of LED chips that the light emitting elements that emit light higher in intensity comprise is larger than the number of LED chips that the other light emitting elements comprise.

6. The light source device according to claim 1,
wherein the plurality of light emitting elements are disposed along the peripheral portion of the light guide plate, and
wherein the light emitting elements in the vicinity of the locking member disposed on the peripheral portion of the light guide plate are disposed at a higher density than the other light emitting elements.

7. The light source device according to claim 6, wherein the plurality of light emitting elements comprise LED packages.

8. The light source device according to claim 1, further comprising a light source that comprises the plurality of light emitting elements, and is disposed on the peripheral portion of the light guide plate.

9. The light source device according to claim 8, wherein the light source comprises a substrate comprising the plurality of light emitting elements.

10. The light source device according to claim 1, wherein the locking member disposed on the peripheral portion of the light guide plate comprises either one of a notch and a through hole.

11. A display device comprising:
the light source device according to claim 1; and
a transmissive or transflective display panel, on a back face of which the light source device is disposed,
wherein the light emitted by the light source of the light source device is made into planar light by the light guide plate of the light source device, and is projected onto the back face of the display panel.
